(19) United States
(12) Patent Application Publication
(10) Pub. No.: US 2008/0136869 A1
(43) Pub. Date: Jun. 12, 2008

(54) Fluid Ejection Nozzle

(76) Inventors: Jonathan Morgan, Cambridgeshire (GB); Jonathan Harvey Lucas, Essex (GB)

Correspondence Address: JOHN P. DE LUCA, 17420 RYEFIELD CT., DICKERSON, MD, 20842, US

(21) Appl. No.: 11/793,407

(22) PCT Filed: Dec. 21, 2005
(86) PCT No.: PCT/EP05/56991

§ 371 Date: Jul. 5, 2007

(51) Int. Cl. B41J 2/16; B23P 17/00

(52) U.S. Cl. 347/47; 29/890.1

(57) ABSTRACT

The invention describes a nozzle for a continuous inkjet printer which is moulded from a fluidised sapphire material such as polycrystalline sapphire. Colour pigments may be added to the fluidised material so that nozzles of a particular size may be distinguished by colour.

### FIELD OF THE INVENTION

This invention relates to a fluid ejection nozzle and, in particular, to a fluid ejection nozzle for a continuous inkjet printer.

### BACKGROUND OF THE INVENTION

An ink ejection nozzle for a continuous inkjet printer has to satisfy a number of predetermined requirements.

Referring to FIG. 3 of the attached drawings, the nozzle should have a coned entry side, the cone having a large entry diameter d₂ which tapers to d₁, the diameter of the outlet aperture 11. The diameter d₂ should bear a fixed relationship to d₁ and the two diameters should be concentric. The depth h₁ of the cone should also bear a fixed relationship to the height h₂ of the outlet aperture 11.

Traditionally, the nozzle is formed from sapphire in a number of stages. Firstly, the coned entry is formed by a grinding process. Thereafter, the outlet aperture 11 is struck through and finished to the required size. The traditional method of finishing is manual, using an abrasive wire and, given the extremely small sizes involved, is inherently prone to inaccuracy. Indeed, in our experience, only about 30% of nozzles manufactured using this manually intensive technique, can be put to commercial use.

In forming a nozzle, the first problem to address is to ensure diameter d₁ is both round, to the desired size, and maintained concentric with d₂. If d₁ is made larger than the desired or anticipated size, then one option may be to finish d₁ to the next largest standard size. However, adopting this route might then produce a d₁ to d₂ ratio, and/or an h₁ to h₂ ratio, which falls outside acceptable limits.

When addressing the problems posed by current nozzle manufacturing techniques, there is an over-riding requirement that sapphire be retained as the base material for the nozzle. This is so because the current range of inks widely used in continuous inkjet printers has been optimised for use with sapphire. More particularly, modulation (the process by which ink is converted into droplets) is influenced by boundary interaction between the ink and the nozzle. If the nozzle material were to change, this boundary behaviour would also change, resulting in a requirement to re-formulate commonly used inks.

A further issue with existing nozzles is there is no ready method of determining nozzle size, other than by physical measurement. Given that standard size nozzles are presently formed with apertures of 40, 60 and 75 microns, it is impossible to distinguish between the various sizes by eye; and it is thus easy for an operator to select a nozzle of the incorrect aperture size.

It is an object of this invention to provide a fluid ejection nozzle for a continuous ink jet printer and/or a method of forming a fluid ejection nozzle which will go at least some way in addressing the aforementioned problems; or which will at least provide a novel and useful choice.

### SUMMARY OF THE INVENTION

Accordingly, in one aspect, the invention provides a method of forming a fluid ejection nozzle, said method including the steps of inserting into a mould cavity a fluidised material which is substantially sapphire in composition, the cavity of the mould being shaped to provide the desired nozzle shape; transforming the fluidised material into a self-supporting component within the mould; and withdrawing said component from the mould.

Preferably said fluidised material takes the form of a ceramic based material, more preferably polycrystalline sapphire.

Preferably said method further includes adding a colouring agent to said fluidised material.

Preferably said method further includes selecting the colour of said colouring agent according to the intended nozzle aperture size of said fluid ejection nozzle.

Preferably said component is post-processed after removal from the mould.

In a second aspect the invention provides a fluid ejection nozzle when formed according to the method set forth above.

In a third aspect the invention provides a range of fluid ejection nozzles for use with a continuous inkjet printer formed as set forth above, said range including nozzles of different aperture size wherein those nozzles of the same aperture size are of a common colour which is different from the colour of those nozzles of a different aperture size.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future.

### BRIEF DESCRIPTION OF THE DRAWINGS

FIG. 1: shows a cross section through a mould used for forming a fluid ejection nozzle according to the invention;

FIG. 2: shows a cross section through a fluid ejection nozzle according to the invention;

FIG. 3: shows an enlarged viewed of the section circled in FIG. 2; and

FIG. 4: shows a plan view of the nozzle shown in FIG. 2;

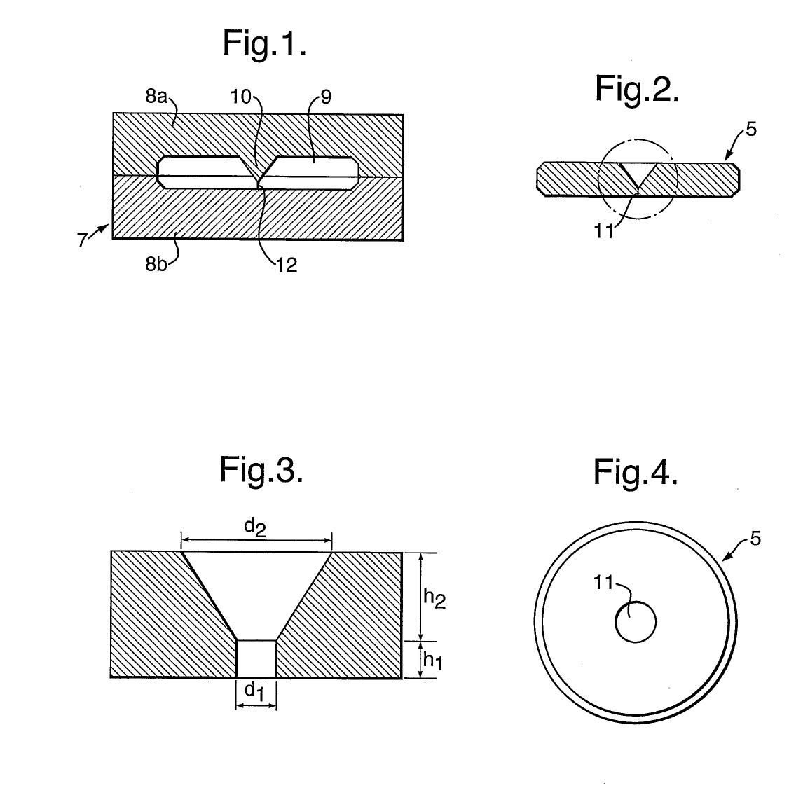

### DETAILED DESCRIPTION OF WORKING EMBODIMENT

As shown in the drawings a fluid ejection nozzle 5 is formed for use with a continuous inkjet printer. The base component which forms the nozzle 5 is formed within a mould 7. Once this base component is self-supporting, it may be withdrawn from the mould and subjected to post treatment, such as curing.

In the form shown the mould 7 comprises mould halves 8a and 8b which, together, define a mould cavity 9. Projecting downwardly from the upper mould half 8a is a conical projection 10 which defines the coned entry to the outlet aperture 11 of the nozzle 5. Projecting upwardly from the centre of the lower mould half 8b is a wire 12 which defines the aperture 11.

We have established that a fluid sapphire-based ceramic material can be obtained. This is preferably in the form of polycrystalline sapphire powder. The powder is mixed with a suitable binder and loaded into the mould cavity 9. Preferably the powder/binder mixture is injected into the mould and retained therein until formed into a self-supporting solid component. This component is then withdrawn from the mould and subjected to post-processing.

A binder is added to the raw powder to enable the raw powder to be injected. Typically the binder comprises a wax and a polymer such as, for example, LDPE.

After removal from the mould, the self-supporting “green” moulding must be subjected to de-binding. This is preferably achieved by heating the moulding so that the binder is caused to melt, decompose and/or evaporate. Obviously this must be undertaken carefully and so as to avoid disruption of the moulded powders, or the formation of voids within the moulding.

After de-binding, the mouldings are subjected to heating so as to weld the powder particles together and form strong unitary components.

The processing and curing of the polycrystalline sapphire results in shrinkage to the base moulded component. Thus the dimensions of the mould cavity and the wire 12 must be selected, in combination with the materials and moulding parameters, to ensure the nozzle 5 is of the requisite dimensions after all processing steps have been completed.

The present invention not only allows nozzles of precise dimensions to be formed reliably and in numbers, but also allows nozzles of different aperture size to be readily identified. Thus, in accordance with a further aspect of the invention, the fluidised sapphire material may have a colouring agent or pigment added thereto before being loaded into the mould cavity 9. In this way nozzles of different colours may be formed. This is particularly useful if different pigments are added for different nozzle sizes as this allows nozzles of different sizes to be readily determined, and avoids nozzles of the wrong size being inadvertently fitted to a print head. By way of example only, 40 micron nozzles may be coloured red, 60 micron nozzles may be coloured blue and 75 micron nozzles may be coloured green.

It will thus be appreciated that the present invention provides a highly reliable and effective means of forming a fluid ejection nozzle for a continuous inkjet printer which has a highly reliable aperture size without the need for any of the intensive yet unreliable labour inputs associated with prior art nozzles. Further, the addition of pigments to the nozzle material allows nozzles of different sizes to be readily distinguished by colour.

1. A method of forming a fluid ejection nozzle, said method including the steps of inserting into a mould cavity a fluidised material which is substantially sapphire in composition, the cavity of the mould being shaped to provide the desired nozzle shape; transforming the fluidised material into a self-supporting component within the mould; and withdrawing said component from the mould.

2. A method as claimed in claim 1 wherein said fluidised material comprises a ceramic based material.

3. A method as claimed in claim 1 wherein said fluidised material comprises polycrystalline sapphire.

4. A method as claimed in claim 1 further including adding a colouring agent to said fluidised material.

5. A method as claimed in claim 4 further including selecting the colour of said colouring agent according to the intended nozzle aperture size of said fluid ejection nozzle.

6. A method as claimed in claim 1 wherein said component is subjected to post treatment after removal from the mould.

7. A fluid ejection nozzle when formed according to the method in claim 1.

8. A range of fluid ejection nozzles, each nozzle as claimed in claim 7, for use with a continuous inkjet printer, said range including nozzles of different aperture size wherein those nozzles of the same aperture size are of a common colour, which colour is different from the colour of those nozzles of a different aperture size.
